(19) United States
(12) Patent Application Publication
(10) Pub. No.: US 2022/0258257 A1
(43) Pub. Date: Aug. 18, 2022

(54) BALL TRACK MILLING CUTTER HAVING A CARRIER BODY, AND METHOD FOR RESTORING A BALL TRACK MILLING CUTTER

(71) Applicant: Guehring KG, Albstadt (DE)

(72) Inventor: Goekmen SANUK, Albstadt Ebingen (DE)

(73) Assignee: Guehring KG, Albstadt (DE)

(21) Appl. No.: 17/653,510

(22) Filed: Mar. 4, 2022

Related U.S. Application Data
(63) Continuation of application No. PCT/DE2020/100780, filed on Sep. 7, 2020.

(30) Foreign Application Priority Data
Sep. 6, 2019 (DE) 10 2019 123 968.0

(51) Int. Cl. B23C 5/10

(52) U.S. Cl. CPC B23C 5/1027

(57) ABSTRACT

The invention relates to a ball track milling cutter (1), comprising a carrier body (2) and at least one cutting element (3) having a cutting edge (31), the carrier body (2) comprising at least one recess (21) for partly receiving the cutting element (3), and the recess (21) being designed to receive a reground cutting element (3) having a reground shape and size.

The invention relates to a ball track milling cutter with a carrier body and a method for restoring a ball track milling cutter according to the respective independent claim.

The invention deals with ball track milling cutters, and lies in the technical field of rotary driven cutting tools.

Such ball track milling cutters comprise a carrier body (holder) that extends along a rotational axis, and a cutting head that is formed on the carrier body or connected thereto, for example. The cutting head has at least one, but frequently four, cutting elements with cutting edges for machining workpieces. To this end, conventional cutting elements are designed as circular arc segment cutting edges. For example, this type of ball track milling cutter is shown in the DE 10 2012 216 654 A1 that originated from the applicant.

The carrier body is usually made out of steel or solid carbide. The cutting elements are preferably designed out of a hard material or with a hard material coating. Known materials for this are CBN (cubic crystalline boron nitride) or PKD (polycrystalline diamond). The cutting elements can be materially fastened to the carrier body, e.g., via soldering or adhesive bonding. It is known to design the several cutting elements fastened to the carrier body as reversible or interchangeable cutting plates.

An essential area of application for these tools involves the manufacture of homokinetic hinges. In this application, the dimensional stability of the used ball track milling cutter is especially important, so as to impart a sufficient quality to the generated surface finish. One problem here is that, given the wear that arises while machining the ball track, the dimensional stability is only ensured for short downtimes, and the cutting plates must be changed.

In the case of worn cutting elements, it has previously been mandatory that the ball track milling cutter be completely exchanged, or that the worn cutting elements be replaced by new cutting elements. For example, the cutting elements are replaced by new cutting elements when the worn cutting elements are unsoldered and new cutting elements are soldered into the carrier body. The problem here becomes a lack of efficiency, since the material for manufacturing the cutting edges is expensive.

For this reason, the object of the invention is to provide a ball track milling cutter with a carrier body for receiving reground cutting elements and a method for restoring ball track milling cutters, which overcomes the disadvantages in prior art, and which in particular provides a ball track milling cutter with reground cutting edges in an economically advantageous manner.

This object is achieved by a ball track milling cutter with a carrier body and a method for restoring a ball track milling cutter according to the respective independent claim. The subject matter of the dependent claims relates to advantageous embodiments.

The invention comprises a ball track milling cutter with a carrier body and at least one cutting element with a cutting edge. The carrier body comprises at least one recess for partly receiving the cutting element. The recess is designed in such a way as to receive a reground cutting element having a reground shape and size. The reground cutting element has a diminished size by comparison to a non-reground cutting element, wherein in particular the width is diminished by the grinding process by 0.1 mm to 0.3 mm, in particular by 0.2 mm. By preparing the carrier body to receive reground cutting elements, the cutting elements can be reused, and only the carrier body has to be exchanged during restoration. Several regrinding cycles can be performed in this way.

According to an advantageous technical aspect, the recess comprises a seat, which the cutting element comes to abut against with a contact surface lying opposite the cutting edge. The seat is designed in such a way as to have the cutting element with a reground shape and size (with part of a surface of the cutting element) arranged on it. The seat advantageously has a rectangular base surface. The width is less than the width of the cutting elements, and forms a shoulder on which the cutting element is arranged.

The seat is preferably flat in design, and has a maximum distance d to an outer surface of the carrier body within a range that exceeds 1 mm, in particular that exceeds 1.5 or 1.7 mm. For example, the distance d can comprise a maximum value for a cutting element shaped like a circular arc segment cutting edge.

According to an advantageous aspect, the maximum distance d to an outer surface of the carrier body lies within a range of 1.5 mm to 3 mm, in particular within a range of 2.2 to 2.8. As a result of these values, a reliable soldered connection is ensured between the cutting element and carrier body.

The recess advantageously comprises a chipping space of the ball cutter. The cutting element can here be arranged on the side wall of the chipping space lying at the front in the rotational direction.

It is especially advantageous for the recess to comprise a ledge upon which the seat is arranged. This makes it possible to form a seat resembling a shoulder in the chipping space.

It is here especially preferable for the ledge to have a width b that is smaller than the width of the cutting element. In this way, stresses during the use of the ball cutter can be readily reduced.

The cutting element with a reground shape and size preferably has a height h within a range that exceeds 1 mm, in particular that exceeds 1.5 or 1.7 mm. Repeated regrinding operations can be ensured based upon these ranges.

It is technically advantageous for the cutting element with a reground shape and size to have a height h within a range of 1.5 mm to 3 mm. A range of 2.2 mm to 2.8 mm has proven itself in practice.

Another aspect of the invention relates to a method for restoring a ball track milling cutter, comprising the following steps:
a) Providing a ball track milling cutter with a carrier body and at least one cutting element arranged thereupon (for example, a ball track milling cutter as described here);
b) Separating the at least one cutting element from the carrier body;
c) Grinding the cutting element;
d) Providing a new carrier body; and
e) Fastening the reground cutting element to the new carrier body.

Exchanging the carrier body makes it possible to reuse the cutting elements in a reground shape.

In step c), providing a new carrier body, a new carrier body with a different geometry by comparison to the carrier body is advantageously provided. The geometry can differ as a whole or in part.

The new carrier body preferably has a recess with a seat, which the reground cutting element comes to abut against with a support surface lying opposite the cutting edge, wherein the seat has a smaller maximum distance d to an outer surface of the carrier body by comparison to the carrier body from step b).

It is further preferable that the seat be straight in design, and have a maximum distance d to an outer surface of the new carrier body within a range that exceeds 1 mm, in particular that exceeds 1.5 or 1.7 mm.

It is additionally advantageous for the maximum distance d to an outer surface of the carrier body to lie within a range of 1.5 mm to 3 mm, in particular within a range of 2.2 to 2.8.

It is here preferred that the cutting element with a reground cutting edge have a height h after step c) within a range of 1.5 mm to 3 mm, in particular within a range of 2.2 to 2.8.

The invention will be additionally explained below based upon the example shown in the drawings.

Shown on:

FIG. 1 is a perspective view of the upper part of a ball track milling cutter according to an example of the invention with a carrier body for receiving cutting elements;

FIG. 2 is a side, top view of the carrier body for the ball track milling cutter from FIG. 1; and

FIG. 3 is a block diagram for a method of restoring a ball track milling cutter, for example of the kind shown on FIG. 1.

FIG. 1 shows a perspective view of the upper part of a ball track milling cutter 1, which in this example comprises four cutting elements 3.

The ball track milling cutter 1 has a carrier body 2, in which a holder and a head section adjoining it from above are integrally molded. Four cutting elements 3 are arranged on the carrier body 2 at an identical angular distance of 90°.

The exterior side of each cutting element 3 has a cutting edge 31, which takes the form of the outline of a circular segment arc section. During regrinding, about 0.2 mm of material are removed from the cutting element 3 on the side of the cutting edge 31.

The carrier body 2 has four recesses 21 for partly receiving a respective cutting element 3. In this example, the recess 21 is designed as a chipping space of the ball track milling cutter 1.

According to the invention, each recess 21 is designed in such a way as to receive a reground cutting element 3 with a reground shape and size, from the exterior side of which about 0.2 mm of material was removed.

In this example, the recess is equipped with a seat 22 elevated in design in such a way that the reground cutting element 3 arranged on the elevated seat 22 runs with the cutting edge 31 above the outer contour of the carrier body 2, as visible on the right half of the image.

The cutting element 3 abuts against the seat 22 with a support surface 32 lying opposite the cutting edge 31. In the example shown, the recess 21 has a ledge 23 upon which the seat 22 is arranged. The ledge 23 has a width b that is smaller than the width of the cutting element 3, so that the cutting element 3 protrudes laterally over the ledge 23.

The seat 22 is here flat in design, and has a maximum distance d to a spherical segment outer surface of the carrier body 2 within a range that exceeds 1 mm, preferably that exceeds 1.5 or 1.7 mm. The selected maximum distance d to an outer surface of the carrier body 2 can advantageously be within a range of 1.5 mm to 3 mm, in particular within a range of 2.2 to 2.8.

Because the carrier body 2 is prepared for receiving 21 reground cutting elements 3, the cutting elements 3 can be reground and reused, and only the carrier body 2 comprised of comparatively favorable material must be exchanged during restoration. In this way, four or more regrinding cycles can conveniently be performed.

In the present example, the cutting element with a reground shape and size has a height h within a range that exceeds 1 mm, in particular that exceeds 1.5 mm or 1.7 mm. It is especially advantageous that the cutting element 3 with a reground shape and size to have a height h within a range of 1.5 mm to 3 mm, in particular within a range of 2.2 mm to 2.8 mm.

FIG. 2 shows a side, top view of the carrier body 2 for the ball track milling cutter from FIG. 1.

The carrier body 2 has a seat 22, which has a flat design and is arranged at an angle ranging from 20° to 50°, in particular 30° to 40°, relative to the rotational axis of the ball track milling cutter.

The seat surface 22 has a maximum distance d to the spherical segment shaped outer surface of the carrier body 2 within a range that exceeds 1 mm, preferably that exceeds 1.5 or 1.7 mm. The selected maximum distance d to an outer surface of the carrier body 2 can advantageously be within a range of 1.5 mm to 3 mm, in particular within a range of 2.2 to 2.8.

FIG. 3 shows a block diagram for explaining the progression of a process for restoring a ball track milling cutter, for example of the kind described here.

The method comprises the following steps:
a) Providing a ball track milling cutter (after used as a tool) with a carrier body and at least one cutting element arranged thereon;
b) Separating the at least one cutting element from the carrier body (for example, via soldering);
c) Grinding the cutting element (wherein material is ground off of the outer edge in such a way that the size and geometry of the cutting element changes);
d) Providing a new carrier body (which has a geometry and size adjusted to the original carrier body, wherein the adjusted geometry is selected in such a way as to allow the reception of the reground cutting element, for example by reducing the distance d); and
e) Fastening the reground cutting element to the new carrier body.

According to a preferred technical aspect, step d) Providing a new carrier body involves providing a new carrier body, which has a different geometry by comparison to the carrier body. To this end, for example, a set of carrier bodies can be used.

The new carrier body advantageously comprises a recess with a seat, against which the reground cutting element comes to abut with a contact surface lying opposite the cutting edge.

The seat has a smaller maximum distance d to an outer surface of the carrier body by comparison to the carrier body from step b).

The prepared seat is straight in design, and advantageously has a maximum distance d to the spherical section shaped outer surface of the new carrier body within a range that exceeds 1 mm, or preferably that exceeds 1.5 or 1.7 mm.

The maximum distance d to an outer surface of the carrier surface lies within a range of 1.5 mm to 3 mm (preferably within a range of 2.2 to 2.8).

After step c), the prepared cutting element with a reground cutting edge has a height h within a range of 1.5 mm to 3 mm, in particular within a range of 2.2 to 2.8.

1. A ball track milling cutter with a carrier body and at least one cutting element with a cutting edge, wherein the carrier body comprises at least one recess for partly receiving the cutting element, and wherein the recess is designed in such a way as to receive a reground cutting element having a reground shape and size.

2. The ball track milling cutter according to claim 1, wherein the recess comprises a seat, which the cutting element comes to abut against with a contact surface lying opposite the cutting edge, and wherein the seat is designed in such a way as to have the cutting element with a reground shape and size arranged on it.

3. The ball track milling cutter according to claim 2, wherein the seat is flat in design, and has a maximum distance to an outer surface of the carrier body within a range that exceeds 1 mm.

4. The ball track milling cutter according to claim 3, wherein the maximum distance to an outer surface of the carrier body lies within a range of 1.5 mm to 3 mm.

5. The ball track milling cutter according to claim 1, wherein the recess comprises a chipping space of the ball cutter.

6. The ball track milling cutter according to claim 2, wherein the recess comprises a ledge upon which the seat is arranged.

7. The ball track milling cutter according to claim 6, wherein the ledge has a width that is smaller than a width of the cutting element.

8. The ball track milling cutter according to claim 1, wherein the cutting element with a reground shape and size has a height within a range that exceeds 1 mm.

9. The ball track milling cutter according to claim 1, wherein the cutting element with a reground shape and size has a height within a range of 1.5 mm to 3 mm.

10. A method for restoring a ball track milling cutter, comprising:
a) Providing a ball track milling cutter with a carrier body and at least one cutting element arranged thereupon;
b) Separating the at least one cutting element from the carrier body;
c) Grinding the cutting element;
d) Providing a new carrier body; and
e) Fastening the reground cutting element to the new carrier body.

11. The method according to claim 10, wherein, in said d) providing a new carrier body, a new carrier body with a different geometry by comparison to the carrier body is provided.

12. The method according to claim 10, wherein the new carrier body comprises a recess with a seat, which the reground cutting element comes to abut against with a support surface lying opposite the cutting edge, wherein the seat has a smaller maximum distance to an outer surface of the carrier body by comparison to the carrier body from said b) Separating the at least one cutting element from the carrier body.

13. The method according to claim 12, wherein the seat is straight in design, and has a maximum distance to an outer surface of the new carrier body within a range that exceeds 1 mm.

14. The method according to claim 13, wherein the maximum distance to an outer surface of the carrier body lies within a range of 1.5 mm to 3 mm.

15. The method according to claim 10, wherein the cutting element with a reground cutting edge has a height, after said c) Grinding the cutting element within a range of 1.5 mm to 3 mm.

16. The ball track milling cutter according to claim 2, wherein the seat is flat in design, and has a maximum distance to an outer surface of the carrier body within a range that exceeds 1.5 mm.

17. The ball track milling cutter according to claim 2, wherein the seat is flat in design, and has a maximum distance to an outer surface of the carrier body within a range that exceeds 1.7 mm.

18. The ball track milling cutter according to claim 3, wherein the maximum distance to an outer surface of the carrier body lies within a range of 2.2 mm to 2.8 mm.

19. The ball track milling cutter according to claim 1, wherein the cutting element with a reground shape and size has a height within a range that exceeds 1.5 mm.

20. The ball track milling cutter according to claim 1, wherein the cutting element with a reground shape and size has a height within a range that exceeds 1.7 mm.

21. The ball track milling cutter according to claim 1, wherein the cutting element with a reground shape and size has a height within a range of 2.2 mm to 2.8 mm.

22. The method according to claim 12, wherein the seat is straight in design, and has a maximum distance to an outer surface of the new carrier body within a range that exceeds 1.5 mm.

23. The method according to claim 12, wherein the seat is straight in design, and has a maximum distance to an outer surface of the new carrier body within a range that exceeds 1.7 mm.

24. The method according to claim 13, wherein the maximum distance to an outer surface of the carrier body lies within a range of 2.2 to 2.8 mm.

25. The method according to claim 10, wherein the cutting element with a reground cutting edge has a height, after said c) Grinding the cutting element, within a range of 2.2 to 2.8 mm.
